(19) United States
(12) Patent Application Publication
(10) Pub. No.: US 2026/0155046 A1
(43) Pub. Date: Jun. 4, 2026

(54) VEHICLE MANAGEMENT APPARATUS AND VEHICLE MANAGEMENT METHOD

(71) Applicant: Mitsubishi Electric Corporation, Tokyo (JP)

(72) Inventors: Dongsuk PARK, Tokyo (JP); Miki ARAI, Tokyo (JP); Takayasu HASHIMOTO, Tokyo (JP); Yuri KUBOTA, Tokyo (JP); Misato WATANABE, Tokyo (JP)

(73) Assignee: Mitsubishi Electric Corporation, Tokyo (JP)

(21) Appl. No.: 18/964,712

(22) Filed: Dec. 2, 2024

Related U.S. Application Data
(63) Continuation of application No. PCT/JP2022/026539, filed on Jul. 4, 2022.

(51) Int. Cl. G08G 1/00; G06Q 10/0833; G08G 1/01

(52) U.S. Cl. CPC G08G 1/22; G06Q 10/0833; G08G 1/0116; G08G 1/20

(57) ABSTRACT

A primary delivery vehicle position sensing unit to sense the position of a primary delivery vehicle; a secondary delivery vehicle position sensing unit to sense the position of a secondary delivery vehicle; a surrounding situation sensing unit to sense the surrounding situation of the primary delivery vehicle and the surrounding situation of the secondary delivery vehicle; and a boarding/alighting instruction unit to make a secondary delivery vehicle to board or alight while allowing a primary delivery vehicle to travel in a boarding/alighting zone on the basis of: results of sensing by the primary delivery vehicle position sensing unit; results of sensing by the secondary delivery vehicle position sensing unit; and results of sensing by the surrounding situation sensing unit are included.

### CROSS-REFERENCE TO RELATED APPLICATION

This application is a Continuation of International Patent Application No. PCT/JP 2022/026539, filed on Jul. 4, 2022, the entire contents of which are incorporated herein by reference.

### TECHNICAL FIELD

The present disclosure relates to a vehicle management apparatus that manages traveling of primary delivery vehicles and secondary delivery vehicles, and a vehicle management method therefor.

### BACKGROUND ART

There has been a conventionally known package delivery system using an operating bus (e.g. see Patent Literature 1). In this package delivery system, after passengers have boarded the operating bus, the operating bus is made to move to a place near a goods pickup location, and is made to park on the road near the pickup location, and packages are put in the operating bus using an automated traveling trolley or the like.

### CITATION LIST

### Patent Literatures

Patent Literature 1: JP 2017-220090 A

### SUMMARY OF INVENTION

### Technical Problem

In the package delivery system disclosed in Patent Literature 1, the operating bus parks on the road near the package pickup location, and packages are put in the parked operating bus using an automated traveling trolley or the like. Accordingly, the operating bus needs to park on the road, and there is a possibility that congestion is brought about near the pickup location.

The present disclosure has been made to solve the problem described above, and an object thereof is to provide a vehicle management apparatus that makes it possible to make a secondary delivery vehicle to board or alight from a primary delivery vehicle that can be loaded with the secondary delivery vehicle, without making the primary delivery vehicle to temporarily park.

### Solution to Problem

A vehicle management apparatus according to the present disclosure includes: a primary delivery vehicle position sensor to perform sensing of a position of a primary delivery vehicle; a secondary delivery vehicle position sensor to perform sensing of a position of a secondary delivery vehicle; a surrounding situation sensor to perform sensing of a surrounding situation of the primary delivery vehicle and a surrounding situation of the secondary delivery vehicle on a basis of a result of sensing by a roadside sensor that is provided to a boarding/alighting zone, and enables sensing of a situation in the boarding/alighting zone; and a boarding/alighting instruction generator to make the secondary delivery vehicle to board or alight from the primary delivery vehicle while allowing the primary delivery vehicle to travel in the boarding/alighting zone on a basis of: a result of the sensing by the primary delivery vehicle position sensor; a result of the sensing by the secondary delivery vehicle position sensor; and the surrounding situation of the primary delivery vehicle or the surrounding situation of the secondary delivery vehicle sensed by the surrounding situation sensor after determining whether the secondary delivery vehicle can board or alight from the primary delivery vehicle from the surrounding situation of the primary delivery vehicle or the surrounding situation of the secondary delivery vehicle.

### Advantageous Effects of Invention

By being configured in the manner described above, the present disclosure makes it possible to make a secondary delivery vehicle to board or alight from a primary delivery vehicle that can be loaded with the secondary delivery vehicle, without making the primary delivery vehicle to temporarily park.

### BRIEF DESCRIPTION OF DRAWINGS

FIG. 1 is a figure depicting a configuration example of a vehicle management system according to a first embodiment.

FIG. 2 is a figure depicting a configuration example of a primary delivery vehicle according to the first embodiment.

FIG. 3 is a figure depicting a configuration example of a secondary delivery vehicle according to the first embodiment.

FIG. 4 is a figure depicting a configuration example of a boarding/alighting zone apparatus according to the first embodiment.

FIG. 5 is a figure depicting a configuration example of a central management apparatus according to the first embodiment.

FIG. 6 is a figure depicting a configuration example of a boarding/alighting control unit in the first embodiment.

FIG. 7 is a flowchart depicting an operation example of the central management apparatus according to the first embodiment.

FIG. 8 is a figure depicting an operation example of the central management apparatus according to the first embodiment.

FIG. 9 is a flowchart depicting an operation example of the central management apparatus according to the first embodiment.

FIG. 10 is a flowchart depicting an operation example of the central management apparatus according to the first embodiment.

FIG. 11 is a flowchart depicting an operation example of the central management apparatus according to the first embodiment.

FIG. 12 is a flowchart depicting an operation example of the central management apparatus according to the first embodiment.

FIG. 13 is a flowchart depicting an operation example of the boarding/alighting control unit in the first embodiment.

FIG. 14 is a figure depicting an operation example of boarding and alighting of a secondary delivery vehicle on and from the primary delivery vehicle according to the first embodiment.

FIG. 15A and FIG. 15B are figures depicting hardware configuration examples of the central management apparatus according to the first embodiment.

### DESCRIPTION OF EMBODIMENTS

Hereinbelow, an embodiment is explained in detail with reference to the figures.

### First Embodiment

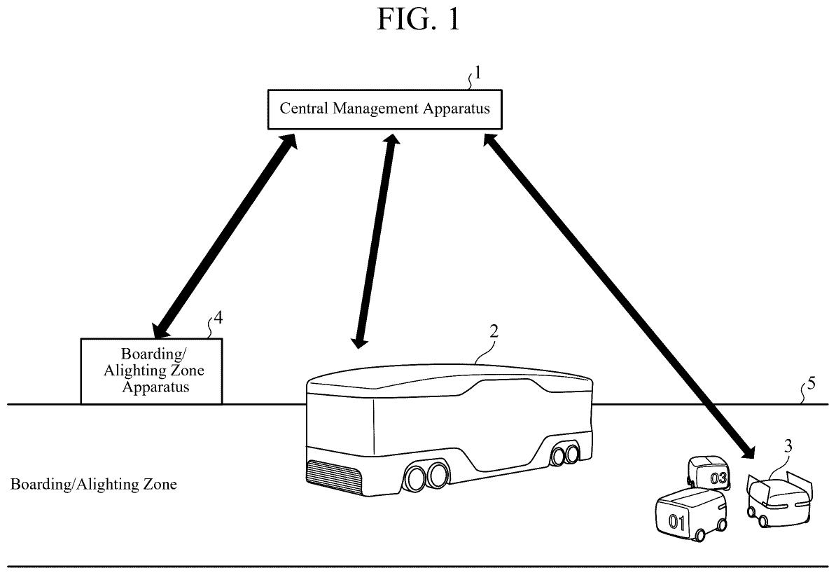

FIG. 1 is a figure depicting a configuration example of a vehicle management system according to a first embodiment.

As depicted in FIG. 1, the vehicle management system includes a central management apparatus 1, a primary delivery vehicle 2, secondary delivery vehicles 3, and a boarding/alighting zone apparatus 4.

The central management apparatus 1 makes the secondary delivery vehicles 3 to board or alight from the primary delivery vehicle 2 without making the primary delivery vehicle 2 to temporarily park in a boarding/alighting zone 5, by performing traveling management of the primary delivery vehicle 2 and the secondary delivery vehicles 3. That is, in the case depicted here, a vehicle management apparatus is applied to the central management apparatus 1. Note that the boarding/alighting zone 5 is a zone where the secondary delivery vehicles 3 can board or alight from the primary delivery vehicle 2 in a state where the primary delivery vehicle 2 is traveling.

In addition, in the exemplary case explained here, in particular, packages are delivered by the traveling management described above performed by the central management apparatus 1.

Details of the central management apparatus 1 are mentioned later.

The primary delivery vehicle 2 is a vehicle that can deliver the secondary delivery vehicles 3. Examples of the primary delivery vehicle 2 include a large-sized vehicle like an operating bus, and, for example, include a goods/passenger-mixedly-carrying vehicle that allows both the secondary delivery vehicles 3 and humans to board and alight.

The primary delivery vehicle 2 delivers the secondary delivery vehicles 3 to a boarding/alighting zone 5 set around the loading position of a package or a boarding/alighting zone 5 set around the unloading position of a package.

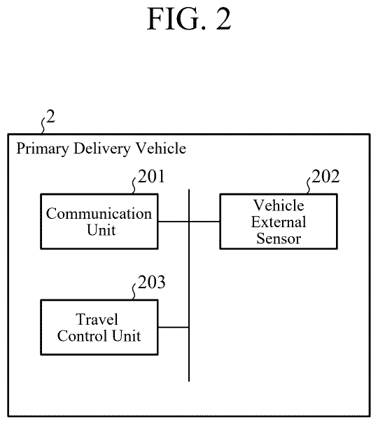

As depicted in FIG. 2, the primary delivery vehicle 2 includes a communication unit 201, a vehicle external sensor 202, and a travel control unit 203.

The communication unit 201 exchanges information with a communication unit 101 provided to the central management apparatus 1.

The vehicle external sensor 202 is a sensor that can sense the surrounding situation of the primary delivery vehicle 2. As the vehicle external sensor 202, for example, one or more of sensors like a camera sensor, a triaxial acceleration sensor, a position sensor (HDL), a LiDAR, a sonar, and the like are used.

Data indicating results of sensing by the vehicle external sensor 202 is sent to the central management apparatus 1 via the communication unit 201 at least in a case where the primary delivery vehicle 2 is in the boarding/alighting zone 5.

The travel control unit 203 controls traveling of the primary delivery vehicle 2 under the control of a driver of the primary delivery vehicle 2 or the central management apparatus 1 at least in a case where the primary delivery vehicle 2 is in the boarding/alighting zone 5. That is, the travel control unit 203 controls the travel route, advancing speed, and the like of the primary delivery vehicle 2 under the control described above.

The secondary delivery vehicles 3 are vehicles that can be loaded with packages, and are vehicles that can board and alight from the primary delivery vehicle 2 in the boarding/alighting zone 5. In addition, it is assumed that the secondary delivery vehicles 3 are small-sized vehicles that can go inside a facility 6 which is a loading position or an unloading position. For example, examples of the secondary delivery vehicles 3 include conveyance robots. In addition, for example, examples of the facility 6 which is a loading position or an unloading position include a commercial facility, a house, and the like.

The secondary delivery vehicles 3 board or alight from the primary delivery vehicle 2 which is traveling in the boarding/alighting zone 5. Then, the secondary delivery vehicles 3 move from the boarding/alighting zone 5 to a loading position, and are loaded with packages. Also, the secondary delivery vehicles 3 move from the boarding/alighting zone 5 to an unloading position, and deliver packages.

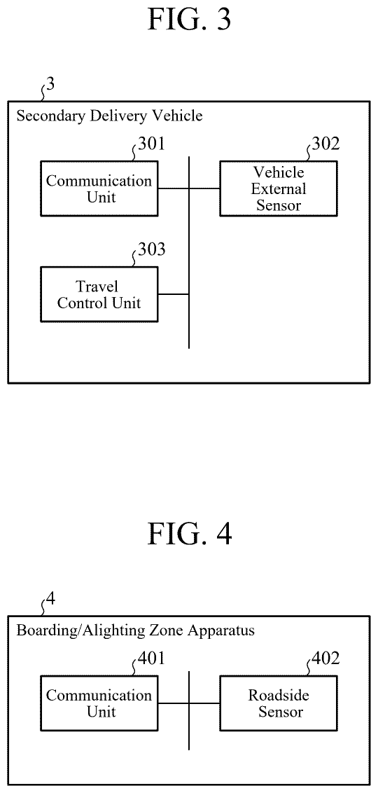

As depicted in FIG. 3, each secondary delivery vehicle 3 includes a communication unit 301, a vehicle external sensor 302, and a travel control unit 303.

The communication unit 301 exchanges information with the communication unit 101 provided to the central management apparatus 1.

The vehicle external sensor 302 is a sensor that can sense the surrounding situation of the secondary delivery vehicle 3. As the vehicle external sensor 302, for example, one or more of sensors like a camera sensor, a triaxial acceleration sensor, a position sensor (HDL), a LiDAR, a sonar, and the like are used.

Data indicating results of sensing by the vehicle external sensor 302 is sent to the central management apparatus 1 via the communication unit 301.

The travel control unit 303 controls traveling of the secondary delivery vehicle 3 under the control of the central management apparatus 1. That is, the travel control unit 303 controls the travel route, advancing speed, and the like of the secondary delivery vehicle 3 under the control described above.

The boarding/alighting zone apparatus 4 is provided to the boarding/alighting zone 5.

As depicted in FIG. 4, the boarding/alighting zone apparatus 4 includes a communication unit 401 and a roadside sensor 402.

The communication unit 401 exchanges information with the communication unit 101 provided to the central management apparatus 1.

The roadside sensor 402 is a sensor makes it possible to sense the situation in the boarding/alighting zone 5. As the roadside sensor 402, for example, one or more of sensors like a camera sensor, a LiDAR, and the like are used. One or more roadside sensors 402 are provided to the boarding/alighting zone 5.

Data indicating results of sensing by the roadside sensors 402 is sent to the central management apparatus 1 via the communication unit 401.

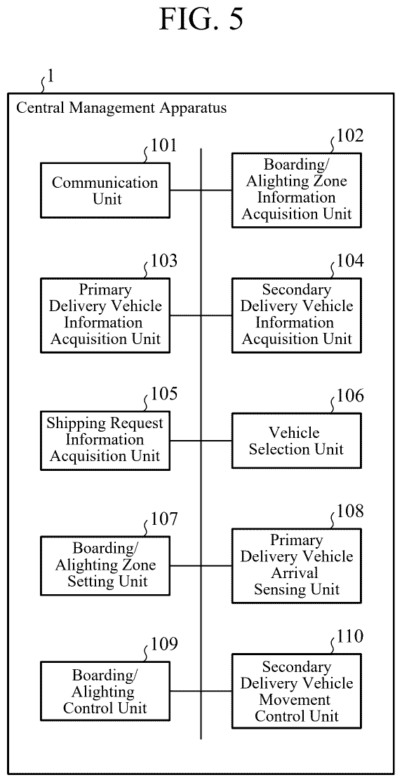

Next, a configuration example of the central management apparatus 1 is explained with reference to FIG. 5.

As depicted in FIG. 5, the central management apparatus 1 includes the communication unit 101, a boarding/alighting zone information acquisition unit 102, a primary delivery vehicle information acquisition unit 103, a secondary delivery vehicle information acquisition unit 104, a shipping request information acquisition unit 105, a vehicle selection unit 106, a boarding/alighting zone setting unit 107, a primary delivery vehicle arrival sensing unit 108, a boarding/alighting control unit 109, and a secondary delivery vehicle movement control unit 110.

The communication unit 101 exchanges information with the communication unit 201 provided to the primary delivery vehicle 2, the communication units 301 provided to the secondary delivery vehicles 3, and the communication unit 401 provided to the boarding/alighting zone apparatus 4.

The boarding/alighting zone information acquisition unit 102 acquires information about the boarding/alighting zone 5. For example, the information about the boarding/alighting zone 5 includes map information indicating the boarding/alighting zone 5, and information indicating the installation locations and sensing areas of the roadside sensors 402 for the boarding/alighting zone 5.

Note that, as the map information indicating the boarding/alighting zone 5 described above, not only fixed map information, but also map information indicating the positions of moving objects such as humans or vehicles that are updated in real time can also be used.

The primary delivery vehicle information acquisition unit 103 acquires information about the primary delivery vehicle 2. For example, the information about the primary delivery vehicle 2 includes information that can identify the primary delivery vehicle 2, information indicating the operating route of the primary delivery vehicle 2, information indicating the number of secondary delivery vehicles 3 that can board the primary delivery vehicle 2, information indicating secondary delivery vehicles 3 that are on board the primary delivery vehicle 2, and the like. Note that it is desirable if the vehicle information acquisition unit acquires the information indicating secondary delivery vehicles 3 on board the primary delivery vehicle 2 every time the information is updated.

The secondary delivery vehicle information acquisition unit 104 acquires information about the secondary delivery vehicles 3. For example, the information about the secondary delivery vehicles 3 include information that can identify the secondary delivery vehicles 3, information indicating the capacity regarding packages that can be loaded onto the secondary delivery vehicles 3, information indicating the package loading statuses of the secondary delivery vehicles 3, information indicating whether or not the secondary delivery vehicles 3 are on board the primary delivery vehicle 2, information indicating the charging statuses of the secondary delivery vehicles 3, and the like. Note that it is desirable if the secondary delivery vehicle information acquisition unit 104 acquires the information indicating the package loading statuses of the secondary delivery vehicles 3, the information indicating whether or not the secondary delivery vehicles 3 are on board the primary delivery vehicle 2, the information indicating the charging statuses of the secondary delivery vehicles 3, and the like every time the information is updated.

The shipping request information acquisition unit 105 acquires information indicating package shipping requests from users. For example, the information indicating package shipping requests includes information indicating the content of packages, information indicating the loading positions of the packages, information indicating the unloading positions of the packages, and the like.

The vehicle selection unit 106 selects a primary delivery vehicle 2. That is, the vehicle selection unit 106 selects a primary delivery vehicle 2 to be used for delivery of a secondary delivery vehicle 3 or a primary delivery vehicle 2 to be used for package delivery.

At this time, the vehicle selection unit 106 makes the selection described above on the basis of: results of acquisition by the boarding/alighting zone information acquisition unit 102; results of acquisition by the primary delivery vehicle information acquisition unit 103; results of acquisition by the secondary delivery vehicle information acquisition unit 104; and results of acquisition by the shipping request information acquisition unit 105.

For the primary delivery vehicle 2 selected by the vehicle selection unit 106, the boarding/alighting zone setting unit 107 sets boarding/alighting zones 5 where a secondary delivery vehicle 3 is made to board or alight. That is, the boarding/alighting zone setting unit 107 sets: a boarding/alighting zone 5 where the secondary delivery vehicle 3 is made to alight from the primary delivery vehicle 2 around the loading position of a package; a boarding/alighting zone 5 where the secondary delivery vehicle 3 is made to board the primary delivery vehicle 2 around the loading position of a package; a boarding/alighting zone 5 where the secondary delivery vehicle 3 is made to alight from the primary delivery vehicle 2 around the unloading position of a package; or a boarding/alighting zone 5 where the secondary delivery vehicle 3 is made to board the primary delivery vehicle 2 around the unloading position of a package.

At this time, the boarding/alighting zone setting unit 107 performs the setting described above on the basis of: results of acquisition by the boarding/alighting zone information acquisition unit 102; results of acquisition by the primary delivery vehicle information acquisition unit 103; results of acquisition by the shipping request information acquisition unit 105; and results of selection by the vehicle selection unit 106.

The primary delivery vehicle arrival sensing unit 108 senses arrival of the primary delivery vehicle 2 selected by the vehicle selection unit 106 at the boarding/alighting zone 5 set by the boarding/alighting zone setting unit 107.

At this time, the primary delivery vehicle arrival sensing unit 108 performs the sensing described above on the basis of at least one of: results of sensing by a roadside sensors 402 provided to a boarding/alighting zone apparatus 4; and results of sensing by the vehicle external sensor 202 provided to the primary delivery vehicle 2.

For example, the primary delivery vehicle arrival sensing unit 108 may sense arrival of the primary delivery vehicle 2 by checking that the primary delivery vehicle 2 which is given information matching information that can identify the primary delivery vehicle 2 acquired by the primary delivery vehicle information acquisition unit 103 has entered the boarding/alighting zone 5 on the basis of results of sensing by the roadside sensors 402 provided to the boarding/alighting zone apparatus 4.

In addition, for example, the primary delivery vehicle arrival sensing unit 108 may sense arrival of the primary delivery vehicle 2 by checking that the primary delivery vehicle 2 has entered an environment matching the environment in the boarding/alighting zone 5 on the basis of results of sensing by the vehicle external sensor 202 provided to the primary delivery vehicle 2.

The boarding/alighting control unit 109 makes a secondary delivery vehicle 3 to board or alight while allowing a primary delivery vehicle 2 to travel in a case where the primary delivery vehicle arrival sensing unit 108 has sensed arrival of the primary delivery vehicle 2 at the boarding/alighting zone 5. That is, the boarding/alighting control unit 109 makes a secondary delivery vehicle 3 to alight from a primary delivery vehicle 2 used for delivery of the secondary delivery vehicle 3, makes a secondary delivery vehicle 3 to board a primary delivery vehicle 2 used for delivery of the secondary delivery vehicle 3, makes a secondary delivery vehicle 3 to alight from a primary delivery vehicle 2 used for package delivery, or makes a secondary delivery vehicle 3 to board a primary delivery vehicle 2 used for package delivery.

At this time, the boarding/alighting control unit 109 performs the boarding/alighting control described above on the basis of one or more of: results of sensing by a roadside sensors 402 provided to a boarding/alighting zone apparatus 4; results of sensing by the vehicle external sensor 202 provided to the primary delivery vehicle 2; and results of sensing by the vehicle external sensor 302 provided to the secondary delivery vehicle 3.

A configuration example of the boarding/alighting control unit 109 is mentioned later.

The secondary delivery vehicle movement control unit 110 makes secondary delivery vehicles 3 to move. That is, the secondary delivery vehicle movement control unit 110 makes a secondary delivery vehicle 3 to move from a boarding/alighting zone 5 to a loading position, makes a secondary delivery vehicle 3 to move from a loading position to a boarding/alighting zone 5, makes a secondary delivery vehicle 3 to move from a boarding/alighting zone 5 to an unloading position, or makes a secondary delivery vehicle 3 to move from an unloading position to a boarding/alighting zone 5.

Note that secondary delivery vehicles 3 are loaded with packages after moving to a loading position. In addition, secondary delivery vehicles 3 deliver packages after moving to an unloading position.

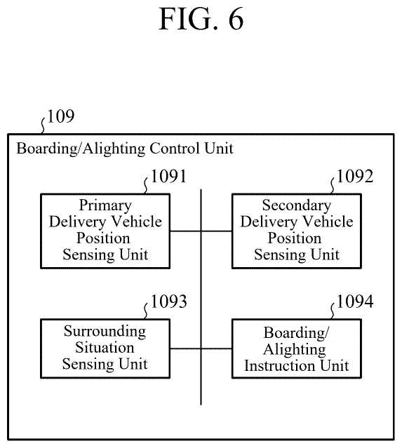

Next, a configuration example of the boarding/alighting control unit 109 is explained with reference to FIG. 6.

As depicted in FIG. 6, the boarding/alighting control unit 109 has a primary delivery vehicle position sensing unit 1091, a secondary delivery vehicle position sensing unit 1092, a surrounding situation sensing unit 1093, and a boarding/alighting instruction unit 1094.

The primary delivery vehicle position sensing unit 1091 senses the positions of primary delivery vehicles 2.

At this time, the primary delivery vehicle position sensing unit 1091 performs the sensing described above on the basis of one or more of: results of sensing by the vehicle external sensor 202 provided to a primary delivery vehicle 2; and results of sensing by the roadside sensors 402 provided to a boarding/alighting zone apparatus 4.

The secondary delivery vehicle position sensing unit 1092 senses the positions of secondary delivery vehicles 3.

At this time, the secondary delivery vehicle position sensing unit 1092 performs the sensing described above on the basis of one or more of: results of sensing by the vehicle external sensor 302 provided to a secondary delivery vehicle 3; and results of sensing by roadside sensors 402 provided to a boarding/alighting zone apparatus 4.

The surrounding situation sensing unit 1093 senses the surrounding situations of primary delivery vehicles 2 and the surrounding situations of secondary delivery vehicles 3.

At this time, the surrounding situation sensing unit 1093 performs the sensing described above on the basis of one or more of: results of sensing by the vehicle external sensor 202 provided to a primary delivery vehicle 2; results of sensing by the vehicle external sensor 302 provided to a secondary delivery vehicle 3; and results of sensing by roadside sensors 402 provided to a boarding/alighting zone apparatus 4.

The boarding/alighting instruction unit 1094 makes a secondary delivery vehicle 3 to board or alight while allowing a primary delivery vehicle 2 to travel in a boarding/alighting zone 5 on the basis of: results of sensing by the primary delivery vehicle position sensing unit 1091; results of sensing by the secondary delivery vehicle position sensing unit 1092; and results of sensing by the surrounding situation sensing unit 1093.

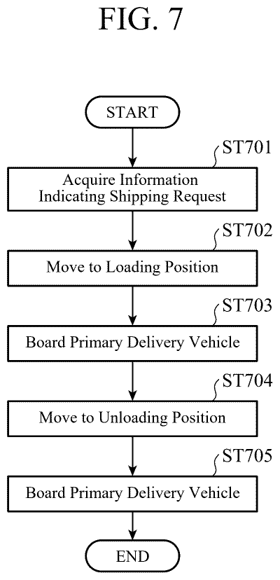

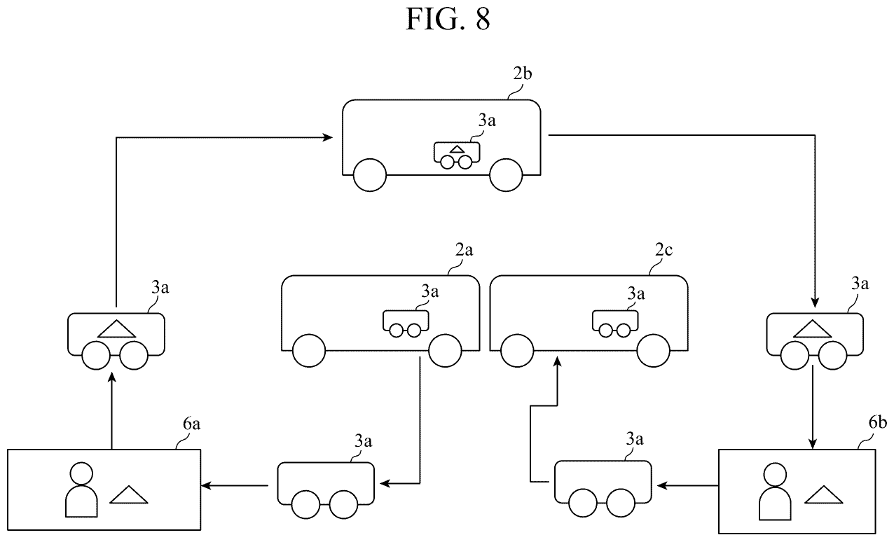

Next, an operation example of the central management apparatus 1 according to the first embodiment depicted in FIGS. 5 and 6 is explained with reference to FIG. 7.

Note that the boarding/alighting zone information acquisition unit 102 has acquired information about boarding/alighting zones 5. In addition, the primary delivery vehicle information acquisition unit 103 has acquired information about primary delivery vehicles 2. In addition, the secondary delivery vehicle information acquisition unit 104 has acquired information about secondary delivery vehicles 3.

In the operation example of the central management apparatus 1 according to the first embodiment depicted in FIGS. 5 and 6, as depicted in FIG. 7, first, the shipping request information acquisition unit 105 acquires information indicating a package shipping request from a user (Step ST701).

Next, the central management apparatus 1 selects a primary delivery vehicle 2 to be used for delivery of a secondary delivery vehicle 3, and, after the primary delivery vehicle 2 arrives at a boarding/alighting zone 5 around the loading position of a package, makes the secondary delivery vehicle 3 to alight from the primary delivery vehicle 2, and makes the secondary delivery vehicle 3 to move to the loading position of the package (Step ST702). Details of Step ST702 are mentioned later.

In an example depicted in FIG. 8, the central management apparatus 1 selects, as the primary delivery vehicle 2, a primary delivery vehicle 2a which a secondary delivery vehicle 3a is on board. Then, in the example depicted in FIG. 8, after the primary delivery vehicle 2a arrives at a boarding/alighting zone 5 around the loading position of the package, the central management apparatus 1 makes the secondary delivery vehicle 3a to alight from the primary delivery vehicle 2a. Then, in the example depicted in FIG. 8, the central management apparatus 1 makes the secondary delivery vehicle 3a to move to a facility 6a, which is the loading position of the package. Thereafter, the package is loaded onto the secondary delivery vehicle 3a at the facility 6a. Note that triangle marks in FIG. 8 mean a package.

Next, the central management apparatus 1 selects a primary delivery vehicle 2 to be used for package delivery, and, after the primary delivery vehicle 2 arrives at a boarding/alighting zone 5 around the loading position of the package, makes the secondary delivery vehicle 3 to board the primary delivery vehicle 2 (Step ST703). Details of Step ST703 are mentioned later.

In the example depicted in FIG. 8, the central management apparatus 1 selects a primary delivery vehicle 2b as the primary delivery vehicle 2. Then, in the example depicted in FIG. 8, after the primary delivery vehicle 2b arrives at the boarding/alighting zone 5 around the loading position of the package, the central management apparatus 1 makes the secondary delivery vehicle 3a, onto which the package has been loaded, to board the primary delivery vehicle 2b.

Next, after the primary delivery vehicle 2 used for package delivery arrives at a boarding/alighting zone 5 around the unloading position of the package, the central management apparatus 1 makes the secondary delivery vehicle 3 to alight from the primary delivery vehicle 2, and makes the secondary delivery vehicle 3 to move to the unloading position of the package (Step ST704). Details of Step ST704 are mentioned later.

In the example depicted in FIG. 8, after the primary delivery vehicle 2b arrives at the boarding/alighting zone 5 around the unloading position of the package, the central management apparatus 1 makes the secondary delivery vehicle 3a to alight from the primary delivery vehicle 2b. Then, in the example depicted in FIG. 8, the secondary delivery vehicle 3a is made to move to a facility 6b, which is the unloading position of the package. Thereafter, the package is carried out from the secondary delivery vehicle 3a at the facility 6b.

Next, the central management apparatus 1 selects a primary delivery vehicle 2 to be used for delivery of the secondary delivery vehicle 3, and after the primary delivery vehicle 2 arrives at a boarding/alighting zone 5 around the unloading position of the package, makes the secondary delivery vehicle 3 to board the primary delivery vehicle 2 (Step ST705). Details of Step ST705 are mentioned later.

In the example depicted in FIG. 8, the central management apparatus 1 selects a primary delivery vehicle 2c as the primary delivery vehicle 2. Then, in the example depicted in FIG. 8, after the primary delivery vehicle 2c arrives at the boarding/alighting zone 5 around the unloading position of the package, the central management apparatus 1 makes the secondary delivery vehicle 3a to board the primary delivery vehicle 2c.

Note that the central management apparatus 1 selects one primary delivery vehicle 2 for each zone as a primary delivery vehicle 2 to be used for delivery of the secondary delivery vehicle 3 in the case depicted in the example depicted in FIG. 8.

However, this is not the sole example. The central management apparatus 1 may select a plurality of primary delivery vehicles 2 as primary delivery vehicles 2 to be used for delivery of the secondary delivery vehicle 3 in one zone. In this case, the secondary delivery vehicle 3 is delivered by the plurality of primary delivery vehicles 2. In this case, the central management apparatus 1 makes the secondary delivery vehicle 3 to transfer between the primary delivery vehicles 2 by a procedure similar to that described above.

In addition, the central management apparatus 1 selects one primary delivery vehicle 2 for each zone as a primary delivery vehicle 2 to be used for package delivery in the case depicted in the example depicted in FIG. 8. However, this is not the sole example. The central management apparatus 1 may select a plurality of primary delivery vehicles 2 as primary delivery vehicles 2 to be used for package delivery in one zone. In this case, the package is delivered by the plurality of primary delivery vehicles 2. In this case, the central management apparatus 1 makes the secondary delivery vehicle 3 loaded with the package to transfer between the primary delivery vehicles 2 by a procedure similar to that described above.

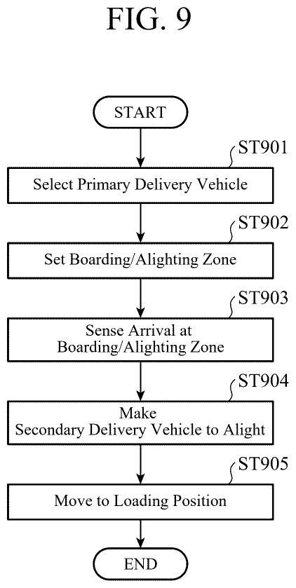

Next, an operation example of Step ST702 performed by the central management apparatus 1 is explained with reference to FIG. 9.

In the operation example of Step ST702 performed by the central management apparatus 1, as depicted in FIG. 9, first, the vehicle selection unit 106 selects a primary delivery vehicle 2 to be used for delivery of a secondary delivery vehicle 3 (Step ST901).

At this time, the vehicle selection unit 106 makes the selection described above on the basis of: results of acquisition by the boarding/alighting zone information acquisition unit 102; results of acquisition by the primary delivery vehicle information acquisition unit 103; results of acquisition by the secondary delivery vehicle information acquisition unit 104; and results of acquisition by the shipping request information acquisition unit 105.

For example, the vehicle selection unit 106 selects, from primary delivery vehicles 2, a primary delivery vehicle 2 that passes a location around the loading position of a package, and which a secondary delivery vehicle 3 that can be loaded with the package is on board.

Note that, in a case where a plurality of secondary delivery vehicles 3 that can be loaded with the package are on board the selected primary delivery vehicle 2, the vehicle selection unit 106 selects a secondary delivery vehicle 3 to be used for package delivery from among them. For example, the vehicle selection unit 106 selects a secondary delivery vehicle 3 on the basis of the charging statuses and the like of the secondary delivery vehicles 3.

Next, for the primary delivery vehicle 2 selected by the vehicle selection unit 106, the boarding/alighting zone setting unit 107 sets a boarding/alighting zone 5 where the secondary delivery vehicle 3 is made to alight from the primary delivery vehicle 2 around the loading position of the package (Step ST902).

At this time, the boarding/alighting zone setting unit 107 performs the setting described above on the basis of: results of acquisition by the boarding/alighting zone information acquisition unit 102; results of acquisition by the primary delivery vehicle information acquisition unit 103; results of acquisition by the shipping request information acquisition unit 105; and results of selection by the vehicle selection unit 106

For example, the boarding/alighting zone setting unit 107 sets the boarding/alighting zone 5 to a geographical point that is on the operating route of the primary delivery vehicle 2, is around the loading position of the package, and is assumed to be not congested.

Next, the primary delivery vehicle arrival sensing unit 108 senses arrival of the primary delivery vehicle 2 selected by the vehicle selection unit 106 at the boarding/alighting zone 5 set by the boarding/alighting zone setting unit 107 (Step ST903).

At this time, the primary delivery vehicle arrival sensing unit 108 performs the sensing described above on the basis of at least one of: results of sensing by roadside sensors 402 provided to a boarding/alighting zone apparatus 4; and results of sensing by the vehicle external sensor 202 provided to the primary delivery vehicle 2.

Next, the boarding/alighting instruction unit 1094 makes the secondary delivery vehicle 3 to alight while allowing the primary delivery vehicle 2 to travel in a case where the primary delivery vehicle arrival sensing unit 108 has sensed arrival of the primary delivery vehicle 2 at the boarding/alighting zone 5 (Step ST904).

At this time, the boarding/alighting instruction unit 1094 performs the boarding/alighting control described above on the basis of one or more of: results of sensing by the roadside sensors 402 provided to a boarding/alighting zone apparatus 4; results of sensing by the vehicle external sensor 202 provided to the primary delivery vehicle 2; and results of sensing by the vehicle external sensor 302 provided to the secondary delivery vehicle 3.

In addition, at this time, the boarding/alighting instruction unit 1094 may ensure the preparation of a space for the boarding/alighting zone 5. For example, in a case where the primary delivery vehicle 2 is provided with a signaling display such as signage, the boarding/alighting instruction unit 1094 may use the signaling display to notify a following vehicle that the secondary delivery vehicle 3 is going to alight from the primary delivery vehicle 2 by displaying text, a video, an icon, or the like. In addition, for example, in a case where a following vehicle is provided with a communication apparatus, the boarding/alighting instruction unit 1094 may use the communication apparatus to notify the following vehicle that the secondary delivery vehicle 3 is going to alight from the primary delivery vehicle 2.

Furthermore, for example, the boarding/alighting instruction unit 1094 may determine the congestion situation of the boarding/alighting zone 5. In a case where the boarding/alighting instruction unit 1094 determines that there is congestion, the boarding/alighting instruction unit 1094 may ensure that there is an alighting space for the secondary delivery vehicle 3 by performing the notification described above, and then making the primary delivery vehicle 2 to move forward. In addition, for example, in a case where the boarding/alighting instruction unit 1094 determines that there is not congestion in the boarding/alighting zone 5, the boarding/alighting instruction unit 1094 may make an adjustment to avoid congestion by giving the notification described above, and then giving a notification for recommending a following vehicle to pass the primary delivery vehicle 2, and ensure that there is an alighting space for the secondary delivery vehicle 3.

Thereby, the boarding/alighting instruction unit 1094 can ensure the preparation of a space for the boarding/alighting zone 5, and can ensure safety.

Next, the secondary delivery vehicle movement control unit 110 makes the secondary delivery vehicle 3 to move from the boarding/alighting zone 5 to the loading position (Step ST905).

Then, the secondary delivery vehicle 3 is loaded with the package after moving to the loading position.

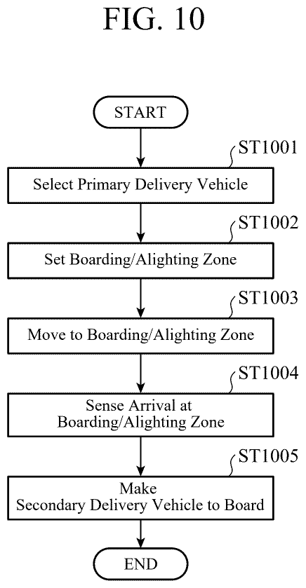

Next, an operation example of Step ST703 performed by the central management apparatus 1 is explained with reference to FIG. 10.

In the operation example of Step ST703 performed by the central management apparatus 1, as depicted in FIG. 10, first, the vehicle selection unit 106 selects a primary delivery vehicle 2 to be used for package delivery (Step ST1001).

At this time, the vehicle selection unit 106 makes the selection described above on the basis of: results of acquisition by the boarding/alighting zone information acquisition unit 102; results of acquisition by the primary delivery vehicle information acquisition unit 103; results of acquisition by the secondary delivery vehicle information acquisition unit 104; and results of acquisition by the shipping request information acquisition unit 105.

For example, the vehicle selection unit 106 selects, from primary delivery vehicles 2, a primary delivery vehicle 2 that passes a location around the loading position of a package and a location around the unloading position of the package, and which a secondary delivery vehicle 3 can board.

Next, for the primary delivery vehicle 2 selected by the vehicle selection unit 106, the boarding/alighting zone setting unit 107 sets a boarding/alighting zone 5 where the secondary delivery vehicle 3 is made to board the primary delivery vehicle 2 around the loading position (Step ST1002).

At this time, the boarding/alighting zone setting unit 107 performs the setting described above on the basis of: results of acquisition by the boarding/alighting zone information acquisition unit 102; results of acquisition by the primary delivery vehicle information acquisition unit 103; results of acquisition by the shipping request information acquisition unit 105; and results of selection by the vehicle selection unit 106

For example, the boarding/alighting zone setting unit 107 sets the boarding/alighting zone 5 to a geographical point that is on the operating route of the primary delivery vehicle 2, is around the loading position of the package, and is assumed to be not congested.

Next, the secondary delivery vehicle movement control unit 110 makes the secondary delivery vehicle 3 to move from the loading position to the boarding/alighting zone 5 set by the boarding/alighting zone setting unit 107 (Step ST1003).

Next, the primary delivery vehicle arrival sensing unit 108 senses arrival of the primary delivery vehicle 2 selected by the vehicle selection unit 106 at the boarding/alighting zone 5 set by the boarding/alighting zone setting unit 107 (Step ST1004).

At this time, the primary delivery vehicle arrival sensing unit 108 performs the sensing described above on the basis of at least one of: results of sensing by the roadside sensors 402 provided to a boarding/alighting zone apparatus 4; and results of sensing by the vehicle external sensor 202 provided to the primary delivery vehicle 2.

Next, the boarding/alighting instruction unit 1094 makes the secondary delivery vehicle 3 to board while allowing the primary delivery vehicle 2 to travel in a case where the primary delivery vehicle arrival sensing unit 108 has sensed arrival of the primary delivery vehicle 2 at the boarding/alighting zone 5 (Step ST1005).

At this time, the boarding/alighting instruction unit 1094 performs the boarding/alighting control described above on the basis of one or more of: results of sensing by the roadside sensors 402 provided to a boarding/alighting zone apparatus 4; results of sensing by the vehicle external sensor 202 provided to the primary delivery vehicle 2; and results of sensing by the vehicle external sensor 302 provided to the secondary delivery vehicle 3.

In addition, at this time, the boarding/alighting instruction unit 1094 may ensure the preparation of a space for the boarding/alighting zone 5. For example, in a case where the primary delivery vehicle 2 is provided with a signaling display such as signage, the boarding/alighting instruction unit 1094 may use the signaling display to notify a following vehicle that the secondary delivery vehicle 3 is going to board the primary delivery vehicle 2 by displaying text, a video, an icon, or the like. In addition, for example, in a case where a following vehicle is provided with a communication apparatus, the boarding/alighting instruction unit 1094 may use the communication apparatus to notify the following vehicle that the secondary delivery vehicle 3 is going to board the primary delivery vehicle 2.

Furthermore, for example, the boarding/alighting instruction unit 1094 may determine the congestion situation of the boarding/alighting zone 5. In a case where the boarding/alighting instruction unit 1094 determines that there is congestion, the boarding/alighting instruction unit 1094 may ensure that there is a boarding space for the secondary delivery vehicle 3 by performing the notification described above, and then making the primary delivery vehicle 2 to move forward. In addition, for example, in a case where the boarding/alighting instruction unit 1094 determines that there is not congestion in the boarding/alighting zone 5, the boarding/alighting instruction unit 1094 may make an adjustment to avoid congestion by giving the notification described above, and then giving a notification for recommending a following vehicle to pass the primary delivery vehicle 2, and ensure that there is a boarding space for the secondary delivery vehicle 3.

Thereby, the boarding/alighting instruction unit 1094 can ensure the preparation of a space for the boarding/alighting zone 5, and can ensure safety.

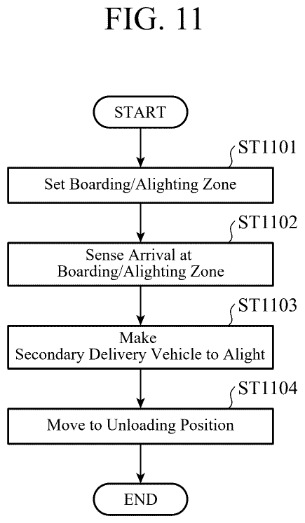

Next, an operation example of Step ST704 performed by the central management apparatus 1 is explained with reference to FIG. 11.

In the operation example of Step ST704 performed by the central management apparatus 1, as depicted in FIG. 11, first, for a primary delivery vehicle 2 selected by the vehicle selection unit 106, the boarding/alighting zone setting unit 107 sets a boarding/alighting zone 5 which is around an unloading position, and where a secondary delivery vehicle 3 is made to alight from the primary delivery vehicle 2 (Step ST1101).

At this time, the boarding/alighting zone setting unit 107 performs the setting described above on the basis of: results of acquisition by the boarding/alighting zone information acquisition unit 102; results of acquisition by the primary delivery vehicle information acquisition unit 103; results of acquisition by the shipping request information acquisition unit 105; and results of selection by the vehicle selection unit 106.

For example, the boarding/alighting zone setting unit 107 sets the boarding/alighting zone 5 to a geographical point that is on the operating route of the primary delivery vehicle 2, is around the unloading position of the package, and is assumed to be not congested.

Next, the primary delivery vehicle arrival sensing unit 108 senses arrival of the primary delivery vehicle 2 selected by the vehicle selection unit 106 at the boarding/alighting zone 5 set by the boarding/alighting zone setting unit 107 (Step ST1102).

At this time, the primary delivery vehicle arrival sensing unit 108 performs the sensing described above on the basis of at least one of: results of sensing by the roadside sensors 402 provided to a boarding/alighting zone apparatus 4; and results of sensing by the vehicle external sensor 202 provided to the primary delivery vehicle 2.

Next, the boarding/alighting instruction unit 1094 makes the secondary delivery vehicle 3 to alight while allowing the primary delivery vehicle 2 to travel in a case where the primary delivery vehicle arrival sensing unit 108 has sensed arrival of the primary delivery vehicle 2 at the boarding/alighting zone 5 (Step ST1103).

At this time, the boarding/alighting instruction unit 1094 performs the boarding/alighting control described above on the basis of one or more of: results of sensing by roadside sensors 402 provided to a boarding/alighting zone apparatus 4; results of sensing by the vehicle external sensor 202 provided to the primary delivery vehicle 2; and results of sensing by the vehicle external sensor 302 provided to the secondary delivery vehicle 3.

In addition, at this time, the boarding/alighting instruction unit 1094 may ensure the preparation of a apace for the boarding/alighting zone 5. For example, in a case where the primary delivery vehicle 2 is provided with a signaling display such as signage, the boarding/alighting instruction unit 1094 may use the signaling display to notify a following vehicle that the secondary delivery vehicle 3 is going to alight from the primary delivery vehicle 2 by displaying text, a video, an icon, or the like. In addition, for example, in a case where a following vehicle is provided with a communication apparatus, the boarding/alighting instruction unit 1094 may use the communication apparatus to notify the following vehicle that the secondary delivery vehicle 3 is going to alight from the primary delivery vehicle 2.

Furthermore, for example, the boarding/alighting instruction unit 1094 may determine the congestion situation of the boarding/alighting zone 5. In a case where the boarding/alighting instruction unit 1094 determines that there is congestion, the boarding/alighting instruction unit 1094 may ensure that there is an alighting space for the secondary delivery vehicle 3 by performing the notification described above, and then making the primary delivery vehicle 2 to move forward. In addition, for example, in a case where the boarding/alighting instruction unit 1094 determines that there is not congestion in the boarding/alighting zone 5, the boarding/alighting instruction unit 1094 may make an adjustment to avoid congestion by giving the notification described above, and then giving a notification for recommending a following vehicle to pass the primary delivery vehicle 2, and ensure that there is an alighting space for the secondary delivery vehicle 3.

Thereby, the boarding/alighting instruction unit 1094 can ensure the preparation of a space for the boarding/alighting zone 5, and can ensure safety.

Next, the secondary delivery vehicle movement control unit 110 makes the secondary delivery vehicle 3 to move from the boarding/alighting zone 5 to the unloading position (Step ST1104).

Then, the secondary delivery vehicles 3 delivers the package after moving to the unloading position.

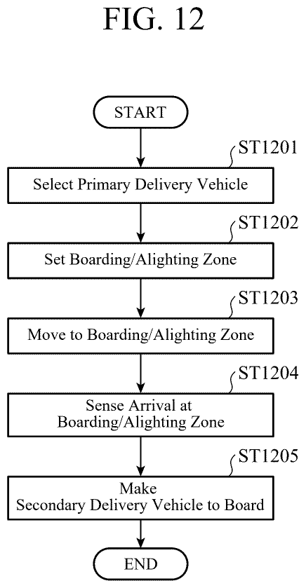

Next, an operation example of Step ST705 performed by the central management apparatus 1 is explained with reference to FIG. 12.

In the operation example of Step ST705 performed by the central management apparatus 1, as depicted in FIG. 12, first, the vehicle selection unit 106 selects a primary delivery vehicle 2 to be used for delivery of a secondary delivery vehicle 3 (Step ST1201).

At this time, the vehicle selection unit 106 makes the selection described above on the basis of: results of acquisition by the boarding/alighting zone information acquisition unit 102; results of acquisition by the primary delivery vehicle information acquisition unit 103; results of acquisition by the secondary delivery vehicle information acquisition unit 104; and results of acquisition by the shipping request information acquisition unit 105.

For example, the vehicle selection unit 106 selects, from primary delivery vehicles 2, a primary delivery vehicle 2 that passes a location around the unloading position of a package, and which the secondary delivery vehicle 3 can board.

Next, for the primary delivery vehicle 2 selected by the vehicle selection unit 106, the boarding/alighting zone setting unit 107 sets a boarding/alighting zone 5 where the secondary delivery vehicle 3 is made to board the primary delivery vehicle 2 around the unloading position (Step ST1202).

At this time, the boarding/alighting zone setting unit 107 performs the setting described above on the basis of: results of acquisition by the boarding/alighting zone information acquisition unit 102; results of acquisition by the primary delivery vehicle information acquisition unit 103; results of acquisition by the shipping request information acquisition unit 105; and results of selection by the vehicle selection unit 106.

For example, the boarding/alighting zone setting unit 107 sets the boarding/alighting zone 5 to a geographical point that is on the operating route of the primary delivery vehicle 2, is around the unloading position of the package, and is assumed to be not congested.

Next, the secondary delivery vehicle movement control unit 110 makes the secondary delivery vehicle 3 to move from the unloading position to the boarding/alighting zone 5 set by the boarding/alighting zone setting unit 107 (Step ST1203).

Next, the primary delivery vehicle arrival sensing unit 108 senses arrival of the primary delivery vehicle 2 selected by the vehicle selection unit 106 at the boarding/alighting zone 5 set by the boarding/alighting zone setting unit 107 (Step ST1204).

At this time, the primary delivery vehicle arrival sensing unit 108 performs the sensing described above on the basis of at least one of: results of sensing by roadside sensors 402 provided to a boarding/alighting zone apparatus 4; and results of sensing by the vehicle external sensor 202 provided to the primary delivery vehicle 2.

Next, the boarding/alighting instruction unit 1094 makes the secondary delivery vehicle 3 to board while allowing the primary delivery vehicle 2 to travel in a case where the primary delivery vehicle arrival sensing unit 108 has sensed arrival of the primary delivery vehicle 2 at the boarding/alighting zone 5 (Step ST1205).

At this time, the boarding/alighting instruction unit 1094 performs the boarding/alighting control described above on the basis of one or more of: results of sensing by the roadside sensors 402 provided to a boarding/alighting zone apparatus 4; results of sensing by the vehicle external sensor 202 provided to the primary delivery vehicle 2; and results of sensing by the vehicle external sensor 302 provided to the secondary delivery vehicle 3.

In addition, at this time, the boarding/alighting instruction unit 1094 may ensure the preparation of a space for the boarding/alighting zone 5. For example, in a case where the primary delivery vehicle 2 is provided with a signaling display such as signage, the boarding/alighting instruction unit 1094 may use the signaling display to notify a following vehicle that the secondary delivery vehicle 3 is going to board the primary delivery vehicle 2 by displaying text, a video, an icon, or the like. In addition, for example, in a case where a following vehicle is provided with a communication apparatus, the boarding/alighting instruction unit 1094 may use the communication apparatus to notify the following vehicle that the secondary delivery vehicle 3 is going to board the primary delivery vehicle 2.

Furthermore, for example, the boarding/alighting instruction unit 1094 may determine the congestion situation of the boarding/alighting zone 5. In a case where the boarding/alighting instruction unit 1094 determines that there is congestion, the boarding/alighting instruction unit 1094 may ensure that there is a boarding space for the secondary delivery vehicle 3 by performing the notification described above, and then making the primary delivery vehicle 2 to move forward. In addition, for example, in a case where the boarding/alighting instruction unit 1094 determines that there is not congestion in the boarding/alighting zone 5, the boarding/alighting instruction unit 1094 may make an adjustment to avoid congestion by giving the notification described above, and then giving a notification for recommending a following vehicle to pass the primary delivery vehicle 2, and ensure that there is a boarding space for the secondary delivery vehicle 3.

Thereby, the boarding/alighting instruction unit 1094 can ensure the preparation of a space for the boarding/alighting zone 5, and can ensure safety.

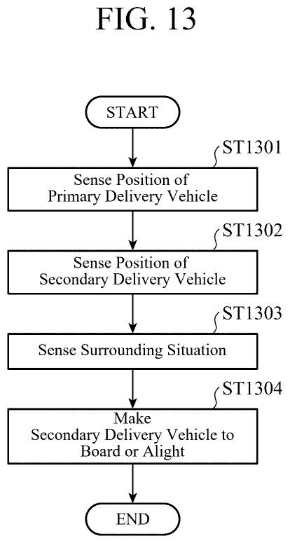

Last, an operation example of the boarding/alighting control unit 109 in the first embodiment depicted in FIG. 6 is explained with reference to FIG. 13.

In the operation example of the boarding/alighting control unit 109 in the first embodiment depicted in FIG. 6, as depicted in FIG. 13, first, the primary delivery vehicle position sensing unit 1091 senses the position of a primary delivery vehicle 2 (Step ST1301).

At this time, the primary delivery vehicle position sensing unit 1091 performs the sensing described above on the basis of one or more of: results of sensing by the vehicle external sensor 202 provided to the primary delivery vehicle 2; and results of sensing by the roadside sensors 402 provided to a boarding/alighting zone apparatus 4.

Next, the secondary delivery vehicle position sensing unit 1092 senses the position of a secondary delivery vehicle 3 (Step ST1302).

At this time, the secondary delivery vehicle position sensing unit 1092 performs the sensing described above on the basis of one or more of: results of sensing by the vehicle external sensor 302 provided to the secondary delivery vehicle 3; and results of sensing by the roadside sensors 402 provided to a boarding/alighting zone apparatus 4.

Next, the surrounding situation sensing unit 1093 senses the surrounding situation of the primary delivery vehicle 2 and the surrounding situation of the secondary delivery vehicle 3 (Step ST1303).

At this time, the surrounding situation sensing unit 1093 performs the sensing described above on the basis of one or more of: results of sensing by the vehicle external sensor 202 provided to the primary delivery vehicle 2; results of sensing by the vehicle external sensor 302 provided to the secondary delivery vehicle 3; and results of sensing by the roadside sensors 402 provided to a boarding/alighting zone apparatus 4.

In addition, by allowing the surrounding situation sensing unit 1093 to use results of sensing by the roadside sensors 402, sensing can be performed in areas that become blind spots if only the vehicle external sensor 202 and the vehicle external sensor 302 are used, in contrast to a case where only results of sensing by the vehicle external sensor 202 and results of sensing by the vehicle external sensor 302 are used. In this case, the surrounding situation sensing unit 1093 can sense the surrounding situation more precisely.

Next, the boarding/alighting instruction unit 1094 makes the secondary delivery vehicle 3 to board or alight while allowing the primary delivery vehicle 2 to travel in a boarding/alighting zone 5 on the basis of: results of sensing by the primary delivery vehicle position sensing unit 1091; results of sensing by the secondary delivery vehicle position sensing unit 1092; and results of sensing by the surrounding situation sensing unit 1093 (Step ST1304).

At this time, for example, first, the boarding/alighting instruction unit 1094 determines whether the secondary delivery vehicle 3 can board or alight from the primary delivery vehicle 2 on the basis of the surrounding situation of the boarding/alighting zone 5.

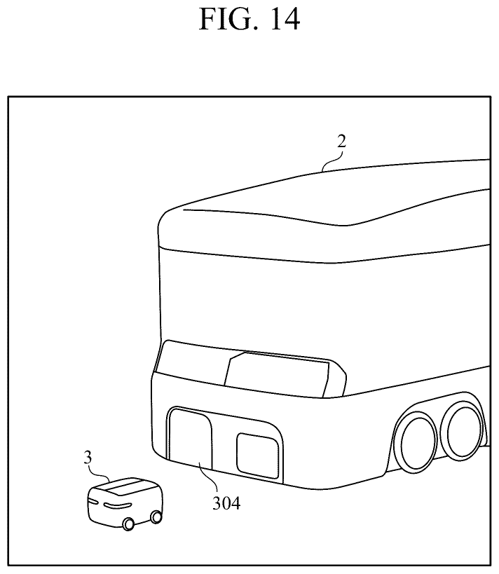

Then, in a case where the boarding/alighting instruction unit 1094 determines that the secondary delivery vehicle 3 can board or alight from the primary delivery vehicle 2, the boarding/alighting instruction unit 1094 instructs the primary delivery vehicle 2 to open its door so as to allow the secondary delivery vehicle 3 to board or alight. Note that, for example, as denoted with a reference sign 204 in FIG. 14, the door is provided to a storage compartment for housing secondary delivery vehicles 3 in the primary delivery vehicle 2. Then, the primary delivery vehicle 2 opens the door in accordance with the instruction described above.

Then, the boarding/alighting instruction unit 1094 makes the secondary delivery vehicle 3 to board or alight while allowing the primary delivery vehicle 2 to travel, by performing traveling control of the primary delivery vehicle 2 and the secondary delivery vehicle 3 according to the positional relationship between the primary delivery vehicle 2 and the secondary delivery vehicle 3. At this time, the boarding/alighting instruction unit 1094 may perform the traveling control further taking into consideration the speeds or inclinations of the primary delivery vehicle 2 and the secondary delivery vehicle 3, the road surface condition of the boarding/alighting zone 5, the inclination of the road surface, and the like. For example, in a case where the secondary delivery vehicle 3 is to be made to alight from the primary delivery vehicle 2, the boarding/alighting instruction unit 1094 increases the speed of the secondary delivery vehicle 3 relative to the speed of the primary delivery vehicle 2 to make the secondary delivery vehicle 3 to alight from the primary delivery vehicle 2, and makes the primary delivery vehicle 2 and the secondary delivery vehicle 3 to move in different ways after making them to travel together in a certain zone. In addition, for example, in a case where the secondary delivery vehicle 3 is made to board the primary delivery vehicle 2, after making the primary delivery vehicle 2 and the secondary delivery vehicle 3 to travel together in a certain zone, the boarding/alighting instruction unit 1094 increases the speed of the secondary delivery vehicle 3 relative to the speed of the primary delivery vehicle 2 to make the secondary delivery vehicle 3 to board the primary delivery vehicle 2.

Then, the boarding/alighting instruction unit 1094 instructs the primary delivery vehicle 2 to close the door. Then, the primary delivery vehicle 2 closes the door in accordance with the instruction described above.

Note that, in a case where the boarding/alighting instruction unit 1094 determines that it is difficult to make the secondary delivery vehicle 3 to board or alight from the primary delivery vehicle 2 in the boarding/alighting zone 5, the boarding/alighting instruction unit 1094 terminates implementation of boarding or alighting of the secondary delivery vehicle 3 on or from the primary delivery vehicle 2. In this case, for example, the central management apparatus 1 may instruct the boarding/alighting zone setting unit 107 to set a boarding/alighting zone 5 again.

In this manner, the central management apparatus 1 according to the first embodiment makes a secondary delivery vehicle 3 to board or alight while allowing a primary delivery vehicle 2 to travel depending on the positions of the primary delivery vehicle 2 and the secondary delivery vehicle 3, and the surrounding situations of the primary delivery vehicle 2 and the secondary delivery vehicle 3. Thereby, the central management apparatus 1 according to the first embodiment can make the secondary delivery vehicle 3 to board or alight from the primary delivery vehicle 2 that can be loaded with the secondary delivery vehicle 3, without making the primary delivery vehicle 2 to temporarily park.

In addition, the central management apparatus 1 according to the first embodiment performs the boarding/alighting control described above to deliver packages. Thereby, the central management apparatus 1 according to the first embodiment makes it unnecessary to make a primary delivery vehicle 2 to temporarily park on the road. Accordingly, it is possible to reduce congestion around areas where secondary delivery vehicles 3 are made to board and alight. In addition, the central management apparatus 1 according to the first embodiment makes it unnecessary to provide spaces dedicated for boarding and alighting of secondary delivery vehicles 3. Accordingly, it becomes possible to reduce burden on business operators.

In addition, the central management apparatus 1 according to the first embodiment makes it possible to reduce operating costs as compared to conventional technologies.

That is, the central management apparatus 1 according to the first embodiment makes it possible to dynamically adjust locations where secondary delivery vehicles 3 are made to board and alight. Accordingly, the operation efficiency is enhanced. For example, even in a case where a sudden accident occurs in a boarding/alighting zone 5, the central management apparatus 1 according to the first embodiment can provide another boarding/alighting zone 5, and can flexibly cope with such a situation. In addition, the central management apparatus 1 according to the first embodiment makes it possible to perform matching with primary delivery vehicles 2 using optimal routes. For example, the central management apparatus 1 according to the first embodiment can calculate geographical points where a secondary delivery vehicle 3 is made to board or alight after loading a package and during a process in which an optimal route to a loading position is taken into consideration. Accordingly, the central management apparatus 1 according to the first embodiment can flexibly cope with a situation where a loading position or an unloading position is a private house.

In addition, the central management apparatus 1 according to the first embodiment can manage boarding and alighting of secondary delivery vehicles 3 separately from boarding and alighting of humans.

Note that the vehicle management apparatus is applied to the central management apparatus 1 which is an apparatus different from primary delivery vehicles 2 and secondary delivery vehicles 3 in the case described above. However, this is not the sole example. The vehicle management apparatus may be applied to a primary delivery vehicle 2 or a secondary delivery vehicle 3.

In addition, all components of the vehicle management apparatus are applied to one apparatus in the case described above. However, this is not the sole example. The components of the vehicle management apparatus may be separately applied to two or more apparatuses of the central management apparatus 1, primary delivery vehicles 2, and secondary delivery vehicles 3.

As mentioned above, according to the first embodiment, the vehicle management apparatus includes: the primary delivery vehicle position sensing unit 1091 to sense the position of a primary delivery vehicle 2; the secondary delivery vehicle position sensing unit 1092 to sense the position of a secondary delivery vehicle 3; the surrounding situation sensing unit 1093 to sense the surrounding situation of the primary delivery vehicle 2 and the surrounding situation of the secondary delivery vehicle 3; and the boarding/alighting instruction unit 1094 to make a secondary delivery vehicle 3 to board or alight while allowing a primary delivery vehicle 2 to travel in a boarding/alighting zone 5 on the basis of: results of sensing by the primary delivery vehicle position sensing unit 1091; results of sensing by the secondary delivery vehicle position sensing unit 1092; and results of sensing by the surrounding situation sensing unit 1093. Thereby, the vehicle management apparatus according to the first embodiment can make the secondary delivery vehicle 3 to board or alight from the primary delivery vehicle 2 that can be loaded with the secondary delivery vehicle 3, without making the primary delivery vehicle 2 to temporarily park.

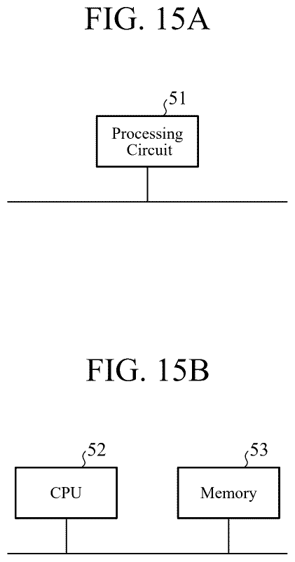

Last, a hardware configuration example of the vehicle management apparatus according to the first embodiment is explained with reference to FIG. 15A and FIG. 15B.

The respective functions of the communication unit 101, the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110 in the central management apparatus 1 are implemented by a processing circuit 51. The processing circuit 51 may be dedicated hardware as depicted in FIG. 15A, or may be a Central Processing Unit (CPU; also referred to as a central processor, a processing unit, a computing device, a microprocessor, a microcomputer, a processor, or a Digital Signal Processor (DSP)) 52 to execute programs stored in a memory 53 as depicted in FIG. 15B.

In a case where the processing circuit 51 is dedicated hardware, for example, the processing circuit 51 is a single circuit, a composite circuit, a programmed processor, a parallel-programmed processor, an Application Specific Integrated Circuit (ASIC), a Field Programmable Gate Array (FPGA), or a combination of these. The function of each of the communication unit 101, the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110 may be implemented by the processing circuit 51, or the functions of the respective units may be collectively implemented by the processing circuit 51.

In a case where the processing circuit 51 is the CPU 52, the functions of the communication unit 101, the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110 are implemented by software, firmware, or a combination of software and firmware. Software and firmware are written as programs, and stored in the memory 53. The processing circuit 51 implements the function of each unit by reading out and executing the programs stored in the memory 53. That is, the central management apparatus 1 includes the memory 53 for storing the programs, execution of which by the processing circuit 51 results in execution of each step depicted in FIGS. 7, and 9 to 13, for example. In addition, these programs can also be said to be programs for causing a computer to execute procedures and methods performed by the communication unit 101, the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110. Here, for example, a non-volatile or volatile semiconductor memory such as a Random Access Memory (RAM), a Read Only Memory (ROM), a flash memory, an Erasable Programmable ROM (EPROM), or an Electrically EPROM (EEPROM), a magnetic disk, a flexible disc, an optical disc, a compact disc, a mini disc, a Digital Versatile Disc (DVD), or the like may be used as the memory 53.

Note that some of the respective functions of the communication unit 101, the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110 may be implemented by dedicated hardware, and some of them may be implemented by software or firmware. For example, it is possible to implement the function of the communication unit 101 using the processing circuit 51 as dedicated hardware, and implement the functions of the boarding/alighting zone information acquisition unit 102, the primary delivery vehicle information acquisition unit 103, the secondary delivery vehicle information acquisition unit 104, the shipping request information acquisition unit 105, the vehicle selection unit 106, the boarding/alighting zone setting unit 107, the primary delivery vehicle arrival sensing unit 108, the boarding/alighting control unit 109, and the secondary delivery vehicle movement control unit 110 by causing the processing circuit 51 to read out and execute programs stored in the memory 53.

In this manner, the processing circuit 51 can implement the respective functions mentioned above by hardware, software, firmware, or a combination of these.

Note that modifications of any components in the embodiment or omissions of any components in the embodiment are possible.

### INDUSTRIAL APPLICABILITY

The vehicle management apparatus according to the present disclosure makes it possible for a secondary delivery vehicle to board or alight from a primary delivery vehicle that can be loaded with the secondary delivery vehicle, without making the primary delivery vehicle to temporarily park, and is suitable for being used for a vehicle management apparatus or the like that manages traveling of primary delivery vehicles and secondary delivery vehicles.

### REFERENCE SIGNS LIST

1: central management apparatus, 2: primary delivery vehicle, 3: secondary delivery vehicle, 4: boarding/alighting zone apparatus, 5: boarding/alighting zone, 6: facility, 51: processing circuit, 52: CPU, 53: memory, 101: communication unit, 102: boarding/alighting zone information acquisition unit, 103: primary delivery vehicle information acquisition unit, 104: secondary delivery vehicle information acquisition unit, 105: shipping request information acquisition unit, 106: vehicle selection unit, 107: boarding/alighting zone setting unit, 108: primary delivery vehicle arrival sensing unit, 109: boarding/alighting control unit, 110: secondary delivery vehicle movement control unit, 201: communication unit, 202: vehicle external sensor, 203: travel control unit, 204: door, 301: communication unit, 302: vehicle external sensor, 303: travel control unit, 401: communication unit, 402: roadside sensor, 1091: primary delivery vehicle position sensing unit, 1092: secondary delivery vehicle position sensing unit, 1093: surrounding situation sensing unit, 1094: boarding/alighting instruction unit

1. A vehicle management apparatus comprising:
a primary delivery vehicle position sensor to perform sensing of a position of a primary delivery vehicle;
a secondary delivery vehicle position sensor to perform sensing of a position of a secondary delivery vehicle;
a surrounding situation sensor to perform sensing of a surrounding situation of the primary delivery vehicle and a surrounding situation of the secondary delivery vehicle on a basis of a result of sensing by a roadside sensor that is provided to a boarding/alighting zone, and enables sensing of a situation in the boarding/alighting zone; and
a processing circuit to make the secondary delivery vehicle to board or alight from the primary delivery vehicle while the primary delivery vehicle travels in the boarding/alighting zone on a basis of:
a result of the sensing by the primary delivery vehicle position sensor;
a result of the sensing by the secondary delivery vehicle position sensor; and
the surrounding situation of the primary delivery vehicle or the surrounding situation of the secondary delivery vehicle sensed by the surrounding situation sensor after determining whether the secondary delivery vehicle can board or alight from the primary delivery vehicle from the surrounding situation of the primary delivery vehicle or the surrounding situation of the secondary delivery vehicle.

2. The vehicle management apparatus according to claim 1, wherein the surrounding situation sensor performs the sensing on a basis of a result of the sensing of the roadside sensor that is provided to the boarding/alighting zone, and enables the sensing of the situation in the boarding/alighting zone, and at least one of a result of the sensing by a vehicle external sensor that is provided to the primary delivery vehicle, and enables the sensing of the surrounding situation of the primary delivery vehicle, a result of the sensing by a vehicle external sensor that is provided to the secondary delivery vehicle, and enables the sensing of the surrounding situation of the secondary delivery vehicle.

3. The vehicle management apparatus according to claim 1, wherein the processing circuit is further configured to:
perform acquisition of information indicating a package shipping request;
select the primary delivery vehicle on a basis of a result of the acquisition of the information indicating the package shipping request acquirer;
set a boarding/alighting zone where the secondary delivery vehicle is made to board or alight from the primary delivery vehicle selected;
a primary delivery vehicle arrival sensor to sense arrival of the primary delivery vehicle selected at the boarding/alighting zone set;
make the secondary delivery vehicle to board or alight from the secondary delivery vehicle while the primary delivery vehicle travels in a case where the primary delivery vehicle arrival sensor has sensed arrival of the primary delivery vehicle at the boarding/alighting zone; and
make the secondary delivery vehicle having been made to alight from the primary delivery vehicle to move, wherein
the processing circuit includes the primary delivery vehicle position sensor, the secondary delivery vehicle position sensor, and the surrounding situation sensor.

4. The vehicle management apparatus according to claim 3, wherein the processing circuit selects the primary delivery vehicle to be used for delivery of the secondary delivery vehicle or the primary delivery vehicle to be used for package delivery.

5. The vehicle management apparatus according to claim 3, wherein the processing circuit sets:
the boarding/alighting zone where the secondary delivery vehicle is made to alight from the primary delivery vehicle around a loading position of a package;
the boarding/alighting zone where the secondary delivery vehicle is made to board the primary delivery vehicle around a loading position of a package;
the boarding/alighting zone where the secondary delivery vehicle is made to alight from the primary delivery vehicle around an unloading position of a package; or
the boarding/alighting zone where the secondary delivery vehicle is made to board the primary delivery vehicle around the unloading position of a package.

6. The vehicle management apparatus according to claim 3, wherein the processing circuit makes the secondary delivery vehicle to alight from the primary delivery vehicle used for delivery of the secondary delivery vehicle, makes the secondary delivery vehicle to board the primary delivery vehicle used for delivery of the secondary delivery vehicle, makes the secondary delivery vehicle to alight from the primary delivery vehicle used for package delivery, or makes the secondary delivery vehicle to board the primary delivery vehicle used for package delivery.

7. The vehicle management apparatus according to claim 3, wherein the processing circuit secondary makes the secondary delivery vehicle to move from the boarding/alighting zone to a loading position of a package, makes the secondary delivery vehicle to move from the loading position of a package to the boarding/alighting zone, makes the secondary delivery vehicle to move from the boarding/alighting zone to an unloading position of a package, or makes the secondary delivery vehicle to move from the unloading position of a package to the boarding/alighting zone.

8. A vehicle management method having:
perform sensing, by a primary delivery vehicle position sensor, of a position of a primary delivery vehicle;
perform sensing, by a secondary delivery vehicle position sensor, of a position of a secondary delivery vehicle;
perform sensing, by a surrounding situation sensor, of a surrounding situation of the primary delivery vehicle and a surrounding situation of the secondary delivery vehicle on a basis of a result of sensing by a roadside sensor that is provided to a boarding/alighting zone, and enables sensing of a situation in the boarding/alighting zone; and
making, by a processing circuit, the secondary delivery vehicle to board or alight from the primary delivery vehicle while the primary delivery vehicle travels in a boarding/alighting zone on a basis of:
a result of the sensing by the primary delivery vehicle position sensor;
a result of the sensing by the secondary delivery vehicle position sensor; and
the surrounding situation of the primary delivery vehicle or the surrounding situation of the secondary delivery vehicle sensed by the surrounding situation sensor after determining whether the secondary delivery vehicle can board or alight from the primary delivery vehicle from the surrounding situation of the primary delivery vehicle or the surrounding situation of the secondary delivery vehicle.

9. The vehicle management method according to claim 8, further comprising:
causing the surrounding situation sensor to perform the sensing on a basis of a result of the sensing of the roadside sensor that is provided to the boarding/alighting zone, and enabling the sensing of the situation in the boarding/alighting zone, and at least one of a result of the sensing by a vehicle external sensor that is provided to the primary delivery vehicle, and enabling the sensing of the surrounding situation of the primary delivery vehicle, a result of the sensing by a vehicle external sensor that is provided to the secondary delivery vehicle, and enables the sensing of the surrounding situation of the secondary delivery vehicle.

10. The vehicle management method according to claim 8, further comprising;
performing acquisition of information indicating a package shipping request;
selecting the primary delivery vehicle on a basis of a result of the acquisition of the information indicating the package shipping request;
setting a boarding/alighting zone where the secondary delivery vehicle is made to board or alight from the primary delivery vehicle selected;
sensing arrival of the primary delivery vehicle selected at the boarding/alighting zone set;
making the secondary delivery vehicle to board or alight from the secondary delivery vehicle while the primary delivery vehicle travels in a case where the primary delivery vehicle arrival sensor has sensed arrival of the primary delivery vehicle at the boarding/alighting zone; and
making the secondary delivery vehicle having been made to alight from the primary delivery vehicle move.

11. The vehicle management method according to claim 10, further comprising selecting the primary delivery vehicle to be used for delivery of the secondary delivery vehicle or the primary delivery vehicle to be used for package delivery.

12. The vehicle management method according to claim 10, further comprising setting:
the boarding/alighting zone where the secondary delivery vehicle is made to alight from the primary delivery vehicle around a loading position of a package;
the boarding/alighting zone where the secondary delivery vehicle is made to board the primary delivery vehicle around a loading position of a package;
the boarding/alighting zone where the secondary delivery vehicle is made to alight from the primary delivery vehicle around an unloading position of a package; or
the boarding/alighting zone where the secondary delivery vehicle is made to board the primary delivery vehicle around the unloading position of a package.

13. The vehicle management method according to claim 10, further comprising making the secondary delivery vehicle to alight from the primary delivery vehicle used for delivery of the secondary delivery vehicle, making the secondary delivery vehicle to board the primary delivery vehicle used for delivery of the secondary delivery vehicle, making the secondary delivery vehicle to alight from the primary delivery vehicle used for package delivery, or making the secondary delivery vehicle to board the primary delivery vehicle used for package delivery.

14. The vehicle management method according to claim 10, further comprising making the secondary delivery vehicle to move from the boarding/alighting zone to a loading position of a package, making the secondary delivery vehicle to move from the loading position of a package to the boarding/alighting zone, making the secondary delivery vehicle to move from the boarding/alighting zone to an unloading position of a package, or making the secondary delivery vehicle to move from the unloading position of a package to the boarding/alighting zone.
